(19) United States
(12) Patent Application Publication
(10) Pub. No.: US 2018/0032967 A1
(43) Pub. Date: Feb. 1, 2018

(54) CALENDAR MANAGEMENT FOR RECOMMENDING AVAILABILITY OF AN INVITEE

(71) Applicant: International Business Machines Corporation, Armonk, NY (US)

(72) Inventors: Thomas W. Barker, Fareham (GB); Marta Gasik, London (GB); Ioannis Georgiou, Attica (GR); Shakib-Bin Hamid, Southampton (GB); James K. Hook, Eastleigh (GB)

(21) Appl. No.: 15/224,759

(22) Filed: Aug. 1, 2016

(51) Int. Cl. G06Q 10/10; G06F 17/30

(52) U.S. Cl. CPC G06Q 10/1095; G06F 17/3053; G06F 17/30867; G06F 17/30528

(57) ABSTRACT

A calendar management system and method for determining an availability of an invitee is provided. The method includes the steps of receiving data from one or more sensors associated with the invitee, the one sensors communicatively coupled to the computing system, wherein the data received by the one or more sensors provides a plurality of metrics of the invitee based on a plurality of factors, assigning, by the processor, a weighting factor to each metric of the plurality of metrics to weight each metric, calculating, by the processor, a total score based on an aggregate of the weighted plurality of metrics, and providing, by the processor, a recommendation as to the availability of the invitee, the recommendation based on the total score.

### BACKGROUND

The present invention relates to systems and methods of a calendar management system, and more specifically to embodiments of a calendar management system and method that takes into account a series of metrics of an invitee to recommend an availability of the invitee.

Calendar management programs can be used to schedule meetings with one or more invitees. Availability data may be used to determine whether or not a meeting is possible. For example, a user may suggest a meeting time to an invitee with the knowledge that this person has no other scheduled meeting at that time. Additional tools have become available to yield a more effective meeting proposal, such as minimizing travel distance for the invitee, and updating real-time changes in time slot availability.

### SUMMARY

An embodiment of the present invention relates to a method, and associated computer system and computer program product, for determining an availability of an invitee. A processor of a computing system receives data from one or more sensors associated with the invitee, the one or more sensors communicatively coupled to the computing system, wherein the data received by the one or more sensors provides a plurality of metrics of the invitee based on a plurality of factors. A weighting factor is assigned, by the processor, to each metric of the plurality of metrics. A total score is calculated, by the processor, based on an aggregate of the weighted plurality of metrics. A recommendation is provided, by the processor, as to the availability of the invitee based on the total score.

### BRIEF DESCRIPTION OF THE DRAWINGS

FIG. 1 depicts a block diagram of a calendar management system, in accordance with embodiments of the present invention.

FIG. 2 depicts a block diagram of a metrics module of the calendar management system of FIG. 1, in accordance with embodiments of the present invention.

FIG, 3 depicts a flow chart of a method for determining an availability recommendation, in accordance with embodiments of the present invention.

FIG. 4 depicts a flow chart of a step of the method of FIG. 3 for providing an availability recommendation based on a total score, in accordance with embodiments of the present invention.

FIG. 5 depicts a flow chart of a step of the method of FIG. 3 for performing an update to the availability recommendation, in accordance with embodiments of the present invention.

FIG. 6 illustrates a block diagram of a computer system for the calendar management system FIG. 1, capable of implementing methods for providing an availability recommendation of FIG. 3, in accordance with embodiments of the present disclosure.

FIG. 7 depicts a cloud computing environment, in accordance with embodiments of the present invention.

FIG. 8 depicts abstraction model layers, in accordance with embodiments of the present invention.

### DETAILED DESCRIPTION

Current methods for calendar management ignore the invitee's preferences, or whether a proposed meeting time is an ideal time to have the meeting. A person can be stressed, overworked, tired, under pressure, or too busy to take a meeting despite having a free time slot. In such cases, the meeting may suffer due to the welfare of the invitee. Information regarding the welfare of the invitee is unavailable to the person who scheduled the meeting because current systems look only to the binary case of yes/no availability. Further, invitees may be unwilling or unable to openly discuss the invitees' stress level and workload with others, especially in a time-pressured scenario.

Thus, a need exists for a calendar management system and method that allows a person to schedule a meeting with an invitee at an ideal time based on the welfare of the invitee, without enquiring too much into their personal life.

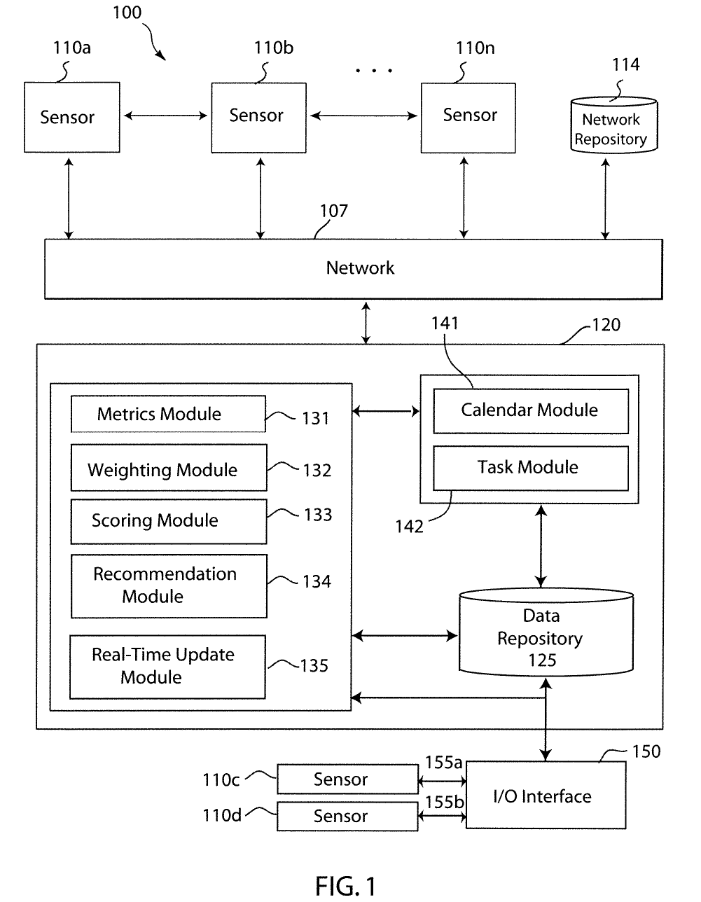

Referring to the drawings, FIG. 1 depicts a block diagram of a calendar management system, in accordance with embodiments of the present invention. Embodiments of a calendar management system 100, which may be described as a welfare-based calendar management system that takes an invitee's preferences and well-being into account to provide, suggest, display, or otherwise deliver a recommendation as to an availability of the invitee. The availability of the invitee as recommended by the calendar management system 100 may encompass both whether the invitee is available during a particular date and time, and whether the proposed meeting time is an optimal, ideal, recommended, efficient, convenient, etc. date and time for the invitee. Embodiments of the calendar management system 100 may provide a granular level of availability of the invitee, which can be represented as a score or numerical rating. The score may be determined by data collected by a plurality of sensors and input devices to provide a plurality of invitee metrics based on a plurality of factors related to the invitee and the invitee's behavior/actions. For instance, the series of invitee metrics may be based on a historical learning system or real-time data relating to a person's individual characteristics. The plurality of factors may be customized so that a different score or rating may be created depending on which factors are relevant or important given the type of meeting requested. In some embodiments, the calendar management system 100 may be a customizable system that may enable a user/third party to query an invitee's availability based on a granular system that considers, for creating a meeting, a current situation or welfare of the invitee, wherein the availability can be represented as a score determined by the system 100. The third party meeting creator may be informed what the invitee(s) would prefer or would be more ideal/optimal when the invitee(s) is/are technically “available” (i.e. no conflicting meeting scheduled in same time slot) over multiple time slots. The third party meeting creator may be informed via various notifications and/or a color coded calendar, wherein a color is associated with a particular availability recommendation. The availability recommendation may be updated as the meeting approaches based on data being collected by the sensors and the input devices, in the event the provided availability recommendation changes based on events and circumstances surrounding the invitee.

Embodiment of calendar management system 100 may comprise one or more sensors 110a, 110b, 110c, 110d, . . . 110n (referred to collectively as “sensors 110”) communicatively coupled to a computing system 120 via an I/O interface 150 and/or over a network 107. For instance, some or all of the sensors 110 may be connected via an I/O interface 150 to computer system 120. The number of sensors 110 connecting to computer system 120 via data bus lines 155a, 155b (referred to collectively as “data bus lines 155) and/or over network 107 may vary from embodiment to embodiment, depending on the number of sensors 110 present in the calendar management system 100. The reference numbers with sub-letters and/or ellipses, for example describing sensors as 110a, 110b, 110c, 110d . . . 110n or the data bus lines as 155a, 155b, may signify that the embodiments are not limited only to the amount of elements actually shown in the drawings, but rather, the ellipses between the letters and the n^{th} element indicate a variable number of similar elements of a similar type. For instance, with regard to the sensors 110 depicted in FIG. 1, any number of a plurality of sensors 110 may be present including sensor 110a, sensor 110b, and a plurality of additional sensors up to the n^{th} number of sensors 110i wherein the variable “n” may represent the last element in a sequence of similar elements shown in the drawing.

As shown in FIG. 1, a number of sensors 110 may transmit data about the invitee or invitee's actions (e.g. “invitee data”) received from the sensor 110 by connecting to computing system 120 via the data bus lines 155 to an 110 interface 150. An 110 interface 150 may refer to any communication process performed between the computer system 120 and the environment outside of the computer system 120, for example, the sensors 110. Input to the computing system 120 may refer to the signals or instructions sent to the computing system 120, for example the data collected by the sensors 110, while output may refer to the signals sent out from the computer system 120 to the sensors 110.

Some or all of the sensors 110 may transmit data about the invitee or invitee's actions (e.g. “invitee data”) received from the sensor 110 and/or input device 111 by connecting to computing system 120 over the network 107. A network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the computer network 107 may be a peer-to-peer network in some embodiments, wherein in other embodiments, the network 107 may be organized as a client/server architecture.

In some embodiments, the network 107 may further comprise, in addition to the computer system 120, and sensors 110, a connection to one or more network accessible knowledge bases containing information of one or more users, network repositories 114 or other systems connected to the network 107 that may be considered nodes of the network 107. In some embodiments, where the computing system 120 or network repositories 114 allocate resources to be used by the other nodes of the network 107, the computer system 120 and network repository 114 may be referred to as servers.

The network repository 114 may be a data collection area on the network 107 which may back up and save all the data transmitted back and forth between the nodes of the network 107. For example, the network repository 114 may be a data center saving and cataloging invitee data sent by one or more of the sensors 110 to generate both historical and predictive reports regarding a particular invitee. In some embodiments, a data collection center housing the network repository 114 may include an analytic module capable of analyzing each piece of data. being stored by the network repository 114. Further, the computer system 120 may be integrated with or as a part of the data collection center housing the network repository 114. In some alternative embodiments, the network repository 114 may be a local repository (not shown) that is connected to the computer system 120.

Referring still to FIG. 1, embodiments of the computing system 120 may receive the invitee data from one or more sensors 110 which may be positioned within an environment shared by the invitee, worn by the invitee, or otherwise disposed in a location that can result in obtaining invitee data. Sensors 110 may be a sensor, an input device, or any input mechanism. For example, sensor 110 may be a biometric sensor, a wearable sensor, an environmental sensor, a camera, a camcorder, a microphone, a peripheral device, a computing device, a mobile computing device, such as a smartphone or tablet, facial recognition sensor, voice capture device, and the like. Embodiments of sensors 110 may also include a heart rate monitor used to track a current or historical average heart rate of the invitee; wireless-enabled wearable technology, such as an activity tracker or smartwatch that tracks a heart rate, an activity level (e.g. number of calories burned, total steps in a day, etc , a quality of sleep, a diet, a number of calories burned; a robotic therapeutic sensor; a blood pressure monitor; a perspiration sensor; and other wearable sensor hardware. Embodiments of sensors 110 may further include environmental sensors either worn or placed in an invitee environment, such as an office or study, that can measure air quality, temperature, pressure, NO₂ levels, humidity, and the like, which may be helpful in suggesting a location of a meeting or to gauge a comfort level of an invitee. Further embodiments of sensor 110 not specifically listed herein may be utilized to collect data about the invitee or invitee behavior or conditions surrounding the invitee environment,

Further embodiments of sensors 110 may include one or more input devices or input mechanisms, including one or more cameras positioned proximate the invitee or within an environment shared by the invitee. The one or more cameras may capture image data or video data of an invitee, including a posture, facial expressions, perspiration, muscle activity, gestures, etc. Embodiments of the sensors 110 may also include one or more microphones positioned nearby the invitee to collect audio relating to the invitee, a keystroke logger that may measure a rate of typing, and other hardware input devices, such as an audio conversion device, digital camera or camcorder, voice recognition devices, graphics tablet, a webcam, VR equipment, mouse, touchpad, stylus, and the like, which may help gauge a work intensity or work output of an invitee. Further embodiments of sensors 110 may include a mobile computing device, such as a smartphone or tablet device, which may run various applications that contain data about the invitee. For example, an invitee's smartphone may include a sleep tracking application that may send sleep data to the computing system 120, or may send relevant social media information to the computing system 120. The mobile computing device as used as sensor may also utilize the device's camera, microphone, and other embedded sensors to send information to the computing system 120. Moreover, embodiments of sensors 110 may encompass other input mechanisms, such as a user computer that may send information to the computing system 120, wherein the user computer may be loaded with software programs that are designed to track a productivity or work output level.

Embodiments of the computer system 120 may he equipped with a memory device which may store the invitee data generated and transmitted as data by the sensors 110.

Furthermore, embodiments of the one or more sensors 110 may be in communication with each other. The sensors 110 may interact with each other for collecting comprehensive, accurate, timely, and organized data, and sending to computing system 120. A first sensor of the one or more sensors 110 may request help from another sensor of the one or more sensors 110 to confirm a condition of the invitee or a data result from the first sensor. For example, a facial recognition sensor may communicatively interact with a perspiration sensor to confirm whether the invitee is indeed sweating, and may additionally communicate with a thermal sensor to determine whether the invitee is possibly sweating based on a temperature of the invitee' environment. Additionally, data received by the computing system 120 that is collected by a first sensor of the one or more sensors 110 may be dependent on another sensor of the one or more sensors 110. For instance, a camera sensor for measuring a posture of the invitee may rely on pressure sensors located within the invitee's chair to send data on pressure points of the invitee's chair. Further, embodiments of the sensors 110 may be synchronized with each other to provide accurate and timely data in combination to the computing system 120. As an example, a heart rate monitor worn by the invitee may be synchronized with the keystroke logger to cohesively report a work intensity of the invitee to the computing system 120. Any sensor may communicate with the other sensors. The interactive communication between the sensors 110 may modify, update, augment, bolster, confirm, reference, etc. data received and/or collected by the sensor, as well as improve the accuracy and efficiency of the data.

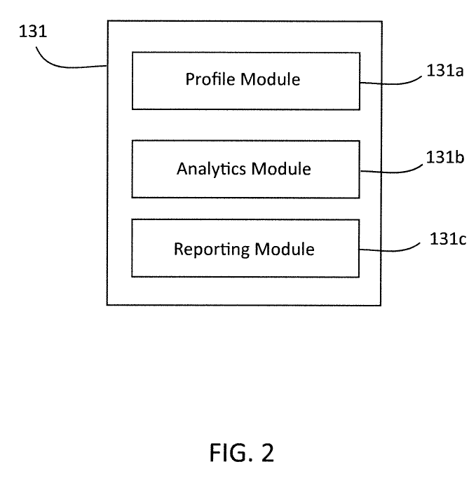

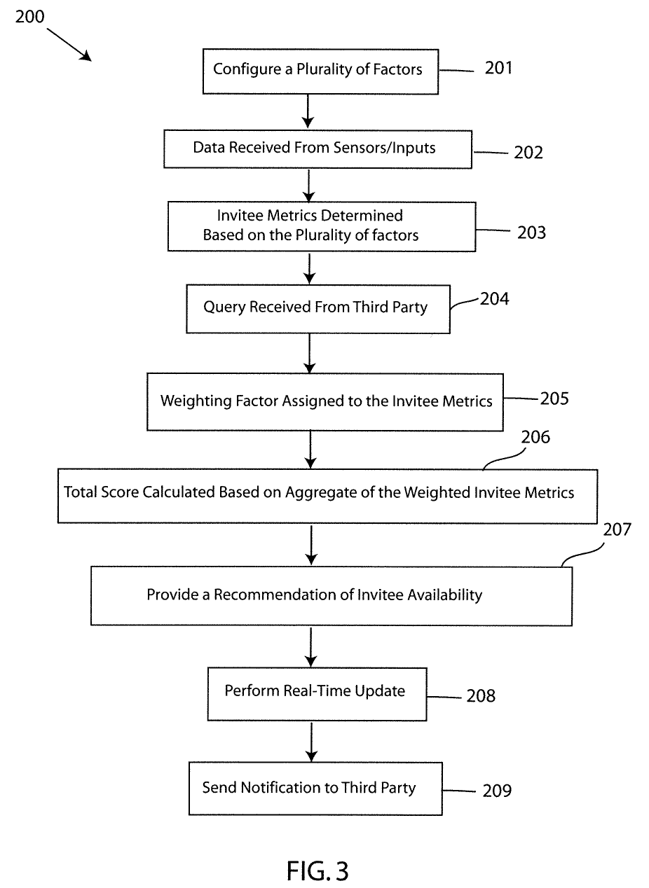

FIG. 2 depicts a block diagram of a metrics module 131 of the calendar management system 100 of FIG. 1, in accordance with embodiments of the present invention. Embodiments of computer system 120 may include a metrics module 131. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines.

Embodiments of the metrics module 131 may include one or more components of hardware and/or software program code for receiving, analyzing, interpreting and reporting data based on the invitee data collected by the sensors 110. Embodiments of the metrics module 131 may generate a series of invitee metrics based on a plurality of factors, including, preferences, tendencies, time since last meeting, rate of activity, general health, stress levels, work intensity, frustration levels, tiredness, work load, pain level, social status, personal/social activity schedule, general welfare, mental health, etc. The series of invitee metrics may be output as a numerical value, such as a metric score or rating. Moreover, embodiments of the metrics module 131 may include a profile module 131a, an analytics module 131b, and/or a reporting module 131c.

Embodiments of the profile module 131a of the metrics module 131 may create, store and organize user profiles and may create and store data received by the computer system 120 from the sensors 110, by associating the data with one or more fields. The profile module 1311a may create, store, and maintain profiles for users of the computing system 120 and/or may register identifying information about users of the computer system 120 as well as coworkers, clients, business contacts, and the like, who may frequently request meetings with or assign tasks to the user/invitee. For instance, offices or business equipped with or operating the calendar management system 100 may obtain personalized information of the invitee without the need for a third party to directly ask the invitee such invasive questions.

Embodiments of the metrics module 131 may also include an analytics module 131b. Embodiments of the analytics module 131b may refer to configurations of hardware, software program code, or combinations of hardware and software programs, capable of analyzing data from one or more sensors 110 and applying one or more data models to discover, identify, interpret and communicate patterns or trends in the invitee data. The analytics module 131b may rely on applications of statistics, computer programming, and the like, of the data collected and received by the analytics module 131b in order to discover, interpret and report patterns in the invitee data. Embodiments of the analytics module 131b may receive invitee data from the sensors 110 and assist the generation of a plurality of invitee metrics based on customizable factors. In further embodiments, the analytics module 131b may receive the data from the sensors 110 and compare the data with other invitees using the calendar management system 100, use the data to generate various reports, such as job performance reports, mental health reports, etc., and predict and/or track tendencies of the invitee.

In some embodiments, the metrics module 131 may also include a reporting module 131c. Embodiments of the reporting module 131c may be hardware, software programs loaded in a memory device or a combination of hardware components and software programs which may provide users, third parties looking to schedule the invitee, and remotely accessible computer systems with information and analytical results of the analytics module 131b, or the metrics module 131 generally. The reporting module 131c may output to the computer system 120 and/or other modules of the computing system 120 results, conclusions, raw data, data, figures, statistics, patterns, and the like, obtained from the sensors 110, that can be used to develop a series of metrics of an invitee.

With continued reference to FIG. 1, embodiments of the computing system 120 of the calendar management system 100 may include a weighting module 132. Embodiments of the weighting module 132 may include one or more components of hardware and/or software program code for assigning a weighting factor to the plurality of invitee metrics generated by the metrics module 131. For example, the weighting module 132 may apply a weighting factor to the metric score generated by the metrics module 131 for a given factor. The weighting factor may be a numerical value applied to the metric score representing a key factor to determine a total score calculated by a scoring module 133. The weighting factor may differ based on which key factors—as measured by the sensors 110, are more meaningful or important to determining an optimal meeting time of an invitee. Exemplary key factors may include invitee preferences, tendencies, time since last meeting, rate of activity, general health, stress levels, work intensity, frustration levels, tiredness, work load, pain level, social status, personal/social activity schedule, general welfare, mental health, etc, As an example, the weighting module 132 may assign a weighting factor, expressed as a multiple of a “weighting” constant, as follows: preferences (weighting×1), tendencies (weighting×1), time since last meeting (weighting×3), rate of activity (weighting×3), general health (weighting×1), stress levels (weighting×1), work intensity (weighting×2), frustration levels (weighting×1), tiredness (weighting×work load (weighting×1), pain level (weighting×1), social status (weighting×1), personal/social activity schedule (weighting×1), general welfare (weighting×1), mental health (weighting×2). The determination of which factors may be used in determining what invitee metrics are provided, and the weighting factor for each factor may be configured and customized by the user, may be out-of-the-box default, may be selectable by the third party meeting creator, or may be automatically determined by the weighting module 133 based on information provided by meeting creator.

Moreover, the weighting module 132 may consider a type of meeting or task requested by a third party when determining a weighting factor to be assigned to a particular metric score associated with a particular factor. For example, if a third party would like to schedule an invitee for a direct customer engagement-type meeting, the selection of factors may be more relevant to a tiredness of the invitee and/or time since last meeting to allow for adequate preparation. In this example, the weighting factor may be higher for the metric score associated with key factors such as tiredness and time since last meeting.

Embodiments of the computing system 120 of the calendar management system 100 may include a scoring module 133. Embodiments of the scoring module 133 may include one or more components of hardware and/or software program code for calculating a total score, or total metric score. The scoring module 133 may first calculate a weighted metric score for each factor, and then may calculate a total score to be used by the recommendation module 134 of the computing system 120. The total score may be represented by a numerical value, which may be the aggregate or sum of all of the weighted metric scores based on each of the plurality of factors. Accordingly, an availability of the user may be outputted as a score or rating by the scoring module 133 (e.g., based on the total score) to be used by the recommendation module 134 to provide an availability recommendation.

With continued reference to FIG. 1, embodiments of the computing system 120 of the calendar management system 100 may include a recommendation module 134. Embodiments of the recommendation module 134 may include one or more components of hardware and/or software program code for providing a recommendation as to an availability of the invitee. Embodiments of the recommendation module 134 may compare the total score calculated by the scoring module 133 with a plurality of predetermined score thresholds. The plurality of predetermined score thresholds may be a range of numerical values associated with a particular recommendation as to the availability of the invitee that takes into account the plurality of key factors as measured by the sensors 110. Exemplary score thresholds may be associated with an optimal availability, a sub-optimal availability, a not recommended but available availability, and an unavailable availability. The recommendation module 134 may respond to a third party query or request to schedule a meeting with a recommendation, suggestion, conclusion, etc. as to an availability or an ideal/optimal availability of the invitee. Moreover, embodiments of the recommendation module 134 may associate the recommendations with a color, wherein each recommendation that indicates a particular score threshold may have a unique color. Thus, a third party may view a color coded invitee schedule, wherein open time slots may be color coded based on characteristics of the invitee to indicate whether a particular time slot is preferred or more optimal than others.

Embodiments of the computing system 120 of the calendar management system 100 may further include a real-time update module 135. Embodiments of the real-time update module 135 may include one or more components of hardware and/or software program code for performing a live data reinforcement of the availability recommendation provided by the recommendation module 134. For example, prior to the accepted meeting, the real-time update module 135 may determine if the availability recommendation has changed or has been affected. Certain factors may affect or change the weighted metric scores for one or more factors, which can change the total score. The real-time update module 135 may determine if such a change has occurred and may either confirm the initial availability recommendation, or may determine that a new total score now exceeds the current predetermined score threshold which changes the recommendation. The real-time update module 135 may notify the third party of the change, and may provide a new recommendation.

Embodiments of the computing system 120 of the calendar management system 100 may include a calendar module 141 and a task module 142. The calendar module 141 and the task module 142 may include one or more components of hardware and/or software program code for performing normal calendar and task operations and functions. Furthermore, various tasks and specific functions of the modules of the computing system 120 may be performed by additional modules, or may be combined into other module(s) to reduce the number of modules.

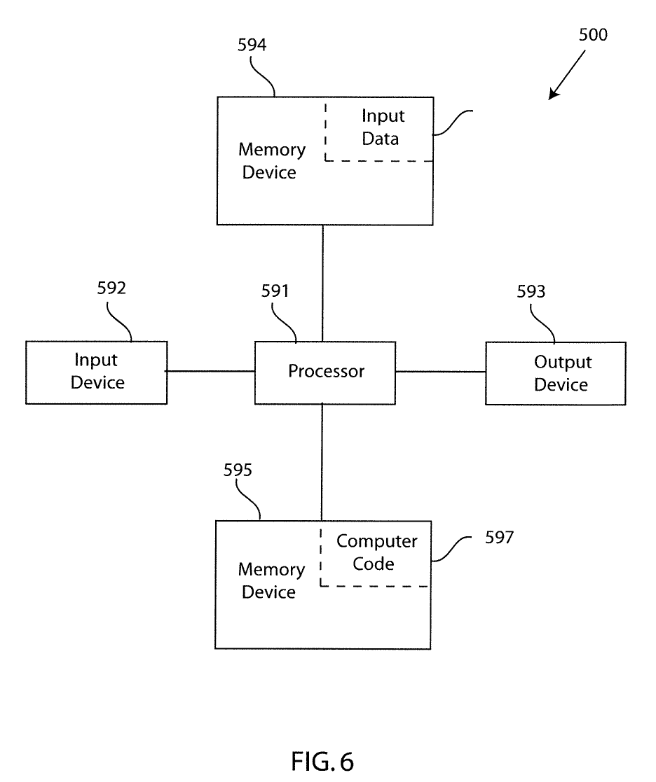

Referring now to FIG. 3, which depicts a flow chart of a method 200 for determining an availability recommendation, in accordance with embodiments of the present invention. One embodiment of a method 200 or algorithm that may be implemented for determining an availability recommendation in accordance with the calendar management system 100 described in FIGS. 1-2 using one or more computer systems as defined generically in FIG. 6 below, and more specifically by the specific embodiments of FIGS. 1-2.

Embodiments of the method 200 for determining an availability recommendation may begin at step 201 wherein a plurality of factors, which may be customizable, are configured and/or selected, unless such factors are designated as default settings In some embodiments, the factors are not configured or are only suggested factors until a third party meeting creator selects the factors. The plurality of factors may relate to an invitee or an invitee's actions or welfare. Exemplary factors may include invitee preferences, tendencies, time since last meeting, rate of activity, general health, stress levels, work intensity, frustration levels, tiredness, work load, pain level, social status, personal/social activity schedule, general welfare, mental health, etc. The invitee may decide which factors should be taken into account when generating a plurality of metrics based on the factors. Alternatively, a third party, such as a meeting creator, may select which factors to be considered, which may be useful because the meeting creator knows which type of meeting is sought.

Data is received by computing system 120 from the sensors HO over network 107 or via I/O interface 150 at step 202. The sensors 110 may continuously collect data and transmit the data to the computing system 120, or may transmit data in response to a query or request by a. third party. The various types of sensors 110 may provide invitee data used to determine a plurality of invitee metrics, wherein the invitee metrics are based on the plurality of selected factors, which may occur at step 203.

At step 204, a query may be received from a third party. Step 204 may be performed at any time before or after step 205. For example, a third party query may be a formal request, or may be accessing and viewing, by the third party, the invitee's schedule looking for an ideal time to request a meeting or assign a task. The query may further involve receiving information from the third party, such as meeting type, location, time, duration, required deliverables, and the like. In some embodiments, the third party query may also include a selection of key factors to be used to return specific, customized invitee metrics. For example, the method 200 may utilize a customized system to enable a third party user to query an invitee's availability based on a granular system based on the invitee's current situation and/or overall welfare. Even if a third party query is not received, method 200 may still perform the steps to provide an availability recommendation for each time slot of an invitee's schedule.

At step 205, a weighting factor is assigned to the invitee metrics. The weighting factor may be applied to the metric score for each factor configured in step 201 and/or selected by the third party as part of the third party query. The weighting factor may be applied after a query is received from a third party, or may be preset by the user prior to receiving a query, or selected by the third party requester at the time of formulating a query. The weighting factor may also be assigned as a function of the type of meeting requested by the third party. The weighting factor may vary for each factor depending on which factor(s)/metric(s) are more important or relevant to determining availability of the invitee, which may result in more customized and relevant scores to determine ideal meeting times and availability of the invitee. The weighting factor may be a numerical value that can multiply the metric score for each factor.

A total metric score is calculated at step 206, given the weighted metric scores for each key factor. Each of the weighted metric scores may be totaled so that the availability of the user is represented as a score or rating. The total score may be the sum or aggregate of the weighted metric scores for each factor, for each time of a plurality of specified times of the day. Based on the calculated total score, the method 200 provides a recommendation as to the availability of the invitee in step 207. The recommendation may then be delivered to the third party requester as a response to the third party query, or output as a color coded schedule accessible by third parties.

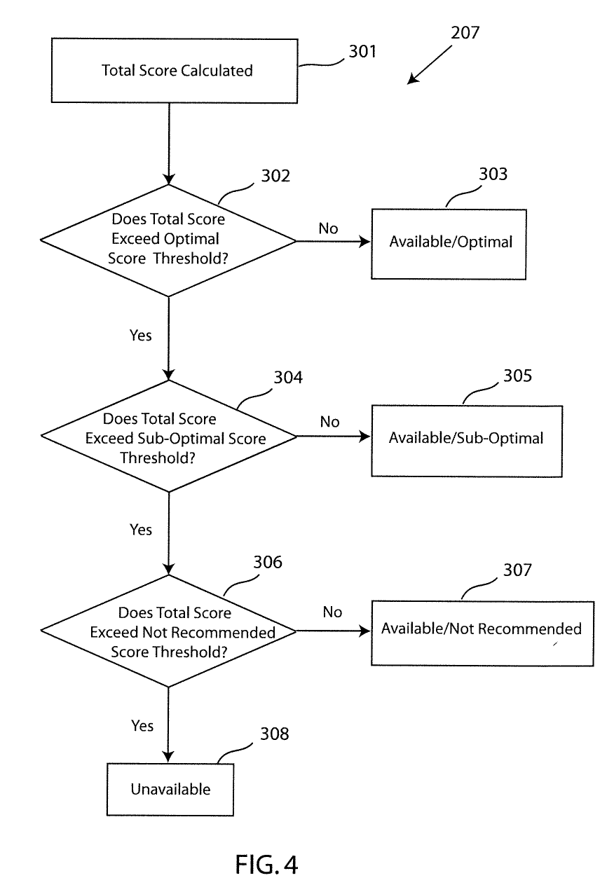

FIG. 4 depicts a flow chart of step 207 of the method of FIG. 3 for providing an availability recommendation based on a total score, in accordance with embodiments of the present invention. At step 301, the total score is calculated as described above. To determine a recommendation as to the availability of the invitee, a comparison may be made between the total score and a plurality of predetermined score thresholds. The plurality of predetermined score thresholds may be a range of numerical values associated with a particular recommendation as to the availability of the invitee that takes into account the plurality of key factors as measured by the sensors 110. Exemplary score thresholds may be associated with an optimal availability, a sub-optimal availability, a not recommended but available availability, and an unavailable availability. Thus, at step 302 determines whether the total score exceeds an “optimal” score threshold. If the total score does not exceed the optimal score threshold, then step 303 determines that the invitee is not only available, but the proposed meeting time is optimal, If the total score does exceed the “optimal” score threshold, then step 304 determines whether the total score exceeds a “sub-optimal” score threshold. If the total score does not exceed the sub-optimal threshold, the invitee is available, then step 305 determines that the proposed meeting time is sub-optimal. If the total score does exceed the “sub-optimal” score threshold, then step 306 determines whether the total score exceeds a “not recommended” score threshold. If the total score does not exceed the “not recommended” threshold, then step 307 determines that the invitee is available, but the proposed meeting time is not recommended. If the total score exceeds the “not recommended” threshold, then step 308 determines that the invitee is unavailable. It should be understood that additional or fewer predetermined score thresholds may be used to further define an availability of the invitee.

Referring back to FIG. 3, embodiments of method 200 may include a step 208 of performing a real-time update to the recommended availability of the invitee, The real-time update step 208 may serve as live-data reinforcement of the availability recommendation provided at step 207. For example, prior to the accepted meeting, method 200 may determine if the availability recommendation has changed or has been affected since the proposed meeting time has been accepted by the invitee. Performing this step may either confirm the initial availability recommendation, or may determine that a new total score now exceeds the current predetermined score threshold which changes the recommendation. Step 209 determines whether a notification should be sent to the third party meeting creator (and other attendees) regarding a change in the availability recommendation provided in step 207.

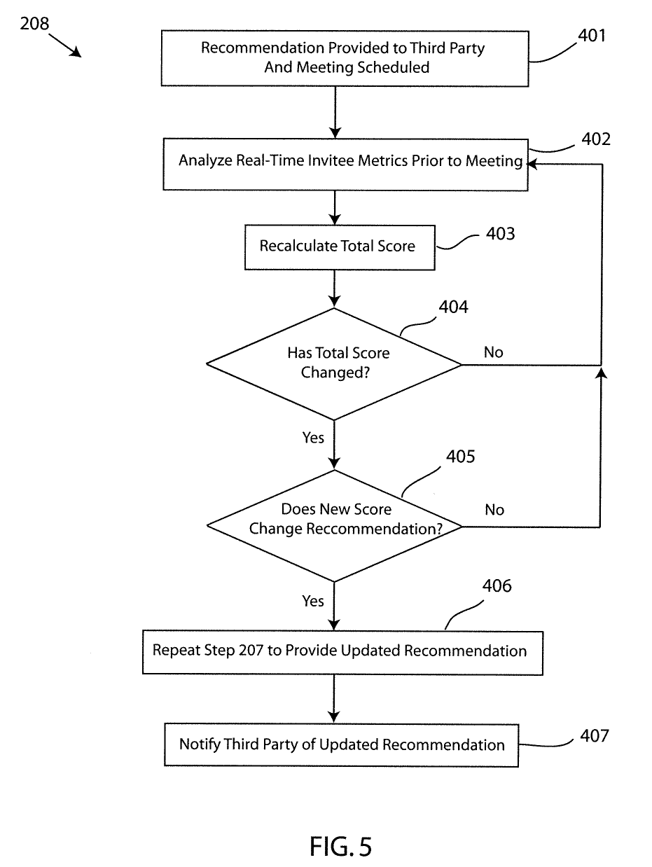

FIG. 5 depicts a flow chart of step 208 of the method 100 of FIG, 3 for performing an update to the availability recommendation, in accordance with embodiments of the present invention. At step 401, an availability recommendation has initially been provided/determined, and a meeting has been scheduled with the invitee. Step 402 analyzes real-time invitee metrics prior to the meeting, which are supplied via the sensors 110. Step 403 calculates a new total score by totaling the updated weighted scores. Step 404 determines whether the new total score is different (or has changed) from the initial total score. If the total score has not changed, then the method 200 may continue to analyze the real-time invitee metrics by returning to step 402. In some embodiments, step 402 is performed at least once prior to the meeting, or at predetermined times before the meeting (e.g. 3 days before meeting, 24 hours before meeting, hour before meeting, etc.). In further embodiments, the method 200 may continuously perform the updating based on new data collected by the sensors 110.

If the total score has changed, step 405 determines whether the new total score changes or affects the previous availability recommendation. If the total score has not changed or affected the previous availability recommendation, then the method 200 may continue to analyze the real-time invitee metrics by returning to step 402. However, if the new total score representing the invitee's availability changes or affects the availability recommendation, then step 406 determines that step 207 in FIG. 3 may be repeated. At step 407 (similar to step FIG. 3) the third party may be notified of the change in the recommendation, and may provide a new availability recommendation.

The following scenario is described for exemplary purposes to show an embodiment of the implementation of method 200:
An executive would like to schedule a project manager for 11:00 AM on Tuesday of the following week to deliver a progress report to a customer. The project manager has a meeting from 9:00 AM to 10:45 AM on the Tuesday. The executive views the project manager's schedule, which is color coded to indicate a recommended availability based on default selections of various key factors. Because the executive needs the project manager to be fully alert and charismatic in front of the customer, the executive selects the following factors—time since last meeting, rate of activity, and tiredness. Because the project manager must deliver a progress report with enthusiasm to the customer, a weighting factor is applied to each of the factors as follows—time since last meeting (×2), rate of activity (×1), and tiredness (×3). A high metric score of 7 is determined for time since last meeting because this leaves only fifteen minutes between meetings, and the project manager likely will have little time to switch contexts. The weighting factor is applied as follows (7)(×2)=14 as the weighted metric score for this factor. The system has determined that last week's rate of activity (e.g. typing rate and stress level) has been lower than usual, indicating that the project manager is likely to continue being a little more relaxed next week as well. Thus, the metric score for the rate of activity factor is a 3. The weighting factor is applied (3)(×1)=3 as the weighted metric score for this factor. The system has also determined that towards the beginning of the week, a sleeping/alertness application on the project manager's smartphone indicates that he has been getting adequate sleep, and historically is well-rested on Tuesday mornings. Therefore, the metric score is 0. The weighting factor is applied: (0)(×3)=0. The total score is calculated by adding up each weighted metric score for each factor: 14+3+0=17. The total score is compared with the following predetermined score thresholds and associated recommendations:
0-10—Available/Optimal
11-20—Available/Sub-Optimal
21-30—Available/Not Recommended
31+—Unavailable.

The total score is 17, which exceeds the predetermined score threshold for optimal (10), but does not exceed the predetermined score threshold for the sub-optimal range (20). Thus, the determination is that the proposed meeting time is a sub-optimal time to schedule a meeting with the invitee, even though he is available. Despite the sub-optimal warning, the executive schedules the meeting with the project manager.

On the day of the meeting (Tuesday), the project manager receives a call at 8:00 AM that a critical situation involving a Problem Management Report (PMR) has come up. As the project manager works hard to resolve the PMR, the sensors (e.g. heart rate monitor, sleep application on mobile phone, and key stroke logger) report the data to the calendar management system, and new values for the metrics associated with tiredness and rate of activity are now higher than usual. The new metric score for rate of activity is 7. The weighting factor is applied to determine the weighted metric score for rate of activity: (7)(×1)=7. The new metric score for tiredness is now a 3. The weighting factor is applied to determine the new weighted score for tiredness: (3)(×3)=9, Time since last meeting weighted score remains unchanged at 14. The total score is calculated by adding up each weighted metric score for each factor: 14+7+9=30. The total score is compared with the following predetermined score thresholds:
0-10—Available/Optimal
11-20—Available/Sub-Optimal
21-30—Available/Not Recommended
31+—Unavailable.

The new total score is 30, which exceeds the predetermined score threshold for optimal (10) and sub-optimal (20), but does not exceed the predetermined score threshold for the available/not recommended range (30). Thus, the determination is that the project manager is available, but the previously accepted meeting time is now not recommended, even though the project manager is available. This change in recommendation is forwarded to the executive, and the executive cancels the meeting and initiates a new query to schedule a meeting on a different day and time due to the importance that the project manager be well rested, prepared, and not overworked for the meeting.

Accordingly, embodiments of method 200 may provide a granular level availability, which is represented by a score, which also allows for a customized list of factors about the invitee or invitee's behavior that may lead to a different score. This may be referred to as a non-binary system and method because the method 200 determines not only whether the invitee is available or not available, but also provides a recommendation on whether the proposed meeting time is optimal, sub-optimal, etc. based upon a plurality of factors, such as the welfare of the invitee. The availability recommendations based on the total score may be displayed as a color coded schedule accessible by others so that meeting creators may view the invitee's schedule and know what meeting times are recommended and which ones are not, without having to ask the invitee invasive and personal health related questions.

FIG. 6 illustrates a block diagram of a computer system 500 that may be included in the system of FIGS. 1-2 and for implementing the methods of FIGS. 3-5 in accordance with the embodiments of the present disclosure. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method for determining an availability recommendation, in the manner prescribed by the embodiments of FIGS. 3-5 using the calendar management system FIGS. 4-5, wherein the instructions of the computer code 597 may be executed by processor 591 via memory device 595. The computer code 597 may include software or program instructions that may implement one or more algorithms for implementing the methods of providing a recommendation as to an availability of an invitee, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 6.

In some embodiments, the computer system 500 may further be coupled to an Input/output (110) interface and a computer data storage unit. An I/O interface may include any system for exchanging information to or from an input device 592 or output device 593. The input device 592 may be, inter alia, a keyboard, a mouse, etc. or in some embodiments the sensors 110. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to calendar management systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to provide an availability recommendation using a plurality of metrics of an invitee based on a plurality of factors. Another embodiment discloses a process for supporting computer infrastructure. There the process includes integrating computer-readable program code into a computer system including a processor.

The step of integrating includes storing the program code in a computer-readable storage device of the computer system through use of the processor. The program code, upon being executed by the processor, implements a method of providing an availability recommendation. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for providing an availability recommendation.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing, device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer nay be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention e described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically, assigned and reassigned according to demand. There is a sense of location independence in that the consumer generally has no control or knowledge over the exact location of the provided resources but may be able to specify location at a higher level of abstraction (e.g., country, state, or datacenter)

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser web-based e-mail). The consumer does not manage or control the underlying cloud infrastructure including network, servers, operating systems, storage, or even individual application capabilities, with the possible exception of limited user-specific application configuration settings.

Platform Service (PaaS): the capability provided to the consumer is to onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

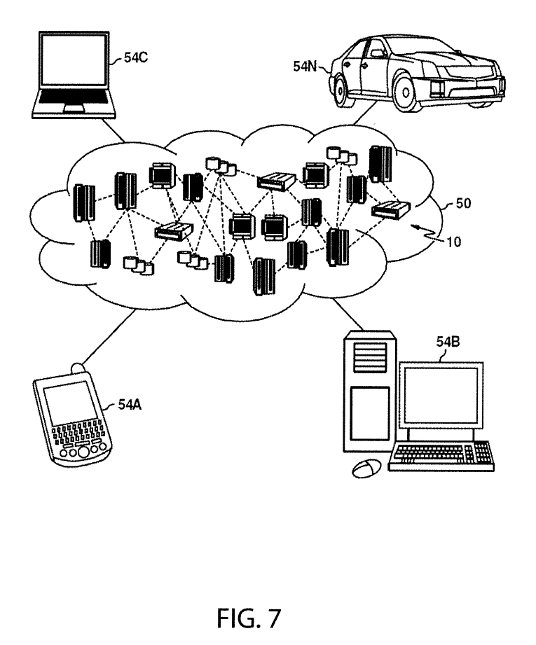

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 7 are intended to be illustrative only and that computing nodes 10 and cloud computing environment 50 can communicate with any type of computerized device over any type of network and/or network addressable connection (e.g., using a web browser)

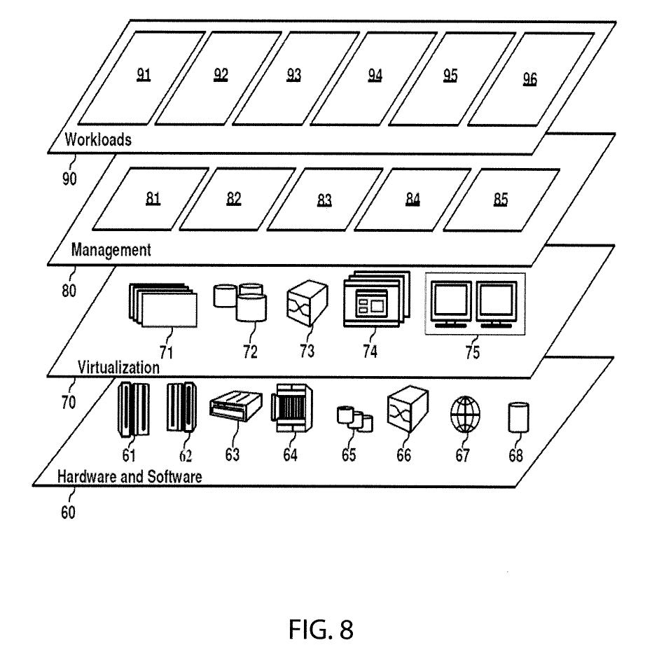

Referring now to FIG. 8, a set of functional abstraction layers provided by cloud computing environment 50 (see FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and calendar management for determining availability of an invitee 96.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein

1. A method for determining an availability of an invitee, the method comprising:
receiving, by a processor of a computing system, data from one or more sensors associated with the invitee, the one or more sensors communicatively coupled to the computing system, wherein the data received by the one or more sensors provides a plurality of metrics of the invitee based on a plurality of factors;
assigning, by the processor, a weighting factor to each metric of the plurality of metrics to weight each metric;
calculating, by the processor, a total score based on an aggregate of the weighted plurality of metrics; and
providing, by the processor, a recommendation as to the availability of the invitee, the recommendation based on the total score.

2. The method of claim 1, comprising: determining by comparing the total score to a plurality of predetermined score thresholds, each score threshold associated with a different level of the availability of the invitee.

3. The method of claim 2, wherein the different levels of availability collectively include available, sub-optimal, not recommended, and unavailable.

4. The method of claim 1, wherein the providing the recommendation comprises providing the recommendation for each time slot of a schedule.

5. The method of claim 1, further comprising: performing, by the processor, an update to the providing step based on live data received from the one or more sensors.

6. The method of claim 1, wherein the plurality of factors include: a time since a last meeting of the invitee, a tiredness level of the invitee, a workload of the invitee, a stress level of the invitee, a rate of activity of the invitee, a frustration level of the invitee, a pain level of the invitee, and a preference of the invitee

7. The method of claim 1, wherein the one or more sensors include a sensor, an input device, an input mechanism, or a combination thereof.

8. A computer system, comprising:
a processor;
a memory device coupled to the processor;
one or more sensors coupled to the processor; and
a computer readable storage device coupled to the processor, wherein the storage device contains program code executable by the processor via the memory device to implement a method for determining an availability of an invitee, the method comprising:
receiving, by the processor, data from the one or more sensors associated with the invitee, wherein data received by the one or more sensors provide a plurality of metrics of the invitee based on a plurality of factors;
assigning, by the processor, a weighting factor to each metric of the plurality of metrics to weight each metric;
calculating, by the processor, a total score based on an aggregate of the weighted plurality of metrics; and
providing, by the processor, a recommendation as to the availability of the invitee, the recommendation based on the total score.

9. The computer system of claim 8, comprising: determining by comparing the total score to a plurality of predetermined score thresholds, each score threshold associated with a different level of the availability of the invitee.

10. The computer system of claim 9, wherein the different levels of availability collectively include available, sub-optimal, not recommended, and unavailable.

11. The computer system of claim 9, wherein the providing the recommendation comprises providing the recommendation for each time slot of a schedule.

12. The computer system of claim 8, further comprising: performing, by the processor, an update to the providing step based on live data received from the one or more sensors.

13. The computer system of claim 8, wherein the plurality of factors include: a time since a last meeting of the invitee, a tiredness level of the invitee, a workload of the invitee, a stress level of the invitee, a rate of activity of the invitee, a frustration level of the invitee, a pain level of the invitee, and a preference of the invitee.

14. The computer system of claim 8, wherein the one or more sensors include a sensor, an input device, an input mechanism, or a combination thereof.

15. A computer program product, comprising a computer readable hardware storage device storing a computer readable program code, the computer readable program code comprising an algorithm that when executed by a computer processor of a computing system implements a method for determining an availability of an invitee, comprising:
receiving, by the processor, data from the one or more sensors associated with the invitee, wherein data received by the one or more sensors provide a plurality of metrics of the invitee based on a plurality of factors;
assigning, by the processor, a weighting factor to each metric of the plurality of metrics to weight each metric;
calculating, by the processor, a total score based on an aggregate of the weighted plurality of metrics; and
providing, by the processor, a recommendation as to the availability of the invitee, the recommendation based on the total score.

16. The computer program product of claim 15, comprising: determining by comparing the total score to a plurality of predetermined score thresholds, each score threshold associated with a different level of the availability of the invitee.

17. The computer program product of claim 16, wherein the different levels of availability collectively include available, sub-optimal, not recommended, and unavailable.

18. The computer program product of claim 16, wherein the providing the recommendation comprises providing the recommendation for each time slot of a schedule

19. The computer program product of claim 15, further comprising: performing, by the processor, an update to the providing step based on live data received from the one or more sensors.

20. The computer program product of claim 15, wherein the one or more sensors include a sensor, an input device, an input mechanism, or a combination thereof.
